(19) United States
(12) Patent Application Publication
(10) Pub. No.: US 2016/0342453 A1
(43) Pub. Date: Nov. 24, 2016

(54) SYSTEM AND METHODS FOR ANOMALY DETECTION

(71) Applicant: Wanclouds, Inc., Santa Clara, CA (US)

(72) Inventors: FAIZ KHAN, San Jose, CA (US); ASWAD RANGNEKAR, Mumbai (IN); MASOOM ALAM, Islamabad (PK)

(21) Appl. No.: 15/160,794

(22) Filed: May 20, 2016

Related U.S. Application Data
(60) Provisional application No. 62/188,346, filed on Jul. 2, 2015.

(30) Foreign Application Priority Data
May 20, 2015 (PK) 288/2015

(51) Int. Cl. G06F 11/07

(52) U.S. Cl. CPC G06F 11/079; G06F 11/0751; G06F 11/0787

(57) ABSTRACT

Log sequence monitoring can be used advantageously in a cloud environment or other system. In at least some embodiments, a cloud administrator or other such entity can use log sequence monitoring tools and/or data to quickly pinpoint a root cause of an anomaly identified through log monitoring. Once the root cause has been determined, the administrator (or other appropriate person, process, or entity) can take appropriate remedial action on the faulty component, service, or other such cause.

### CROSS-REFERENCE TO RELATED APPLICATIONS

This application is a non-provisional application of and claims priority to U.S. Provisional Application No. 62/188,346, filed Jul. 2, 2015, entitled “Anomaly Detection” and claims priority to Pakistan Application No. 288/2015, filed May 20, 2015, entitled “Anomaly Detection,” which are both incorporated herein by reference in their entirety for all purposes.

### BACKGROUND

In networked computing systems, communications often utilize a variety of different operations across a variety of different systems in response to receiving a request through one or more interfaces such as application programming interfaces (APIs). It can be difficult in large distributed environments with interacting services to determine the cause of an error in an operation or API call. It can take from few hours to days for a person, such as a cloud administrator, to determine and understand the exact cause of the error that occurred somewhere across the large and interconnected distributed cloud services. The situation is worsened if the same API requests are being made at the same time by multiple clients and multiple requests are failing to achieve the intended results. Thus, there is a need to improve the identification of a root cause of a problem with a service to allow quick action on a faulty component, service, or system.

### BRIEF DESCRIPTION OF THE DRAWINGS

Various embodiments in accordance with the present disclosure will be described with reference to the drawings, in which:

FIG. 1 illustrates an example block diagram of a system for anomaly detection within a cloud computing provider in accordance with various embodiments;

FIG. 2 illustrates an example block diagram of an administrator console within a cloud computing provider configured for anomaly detection in accordance with various embodiments;

FIG. 3 illustrates an example graphical display of a chain of events for an API call that can be utilized in accordance with various embodiments;

FIG. 4 illustrates an example graphical display of a chain of events across multiple services that shows the interaction of multiple services and an anomaly detected across one or more of the services in accordance with various embodiments;

FIG. 5 illustrates an example flow chart of a process for registering a service with an anomaly detection system in accordance with various embodiments;

FIG. 6 illustrates an example flow chart of a process for detecting an anomaly in one or more services and notifying an administrator of the anomaly in accordance with various embodiments;

FIG. 7 illustrates example components of a computing device that can be used to implement aspects of various embodiments.

FIG. 8 illustrates an example web-based environment that can be used to implement aspects of various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As mentioned above, it can be difficult to determine the cause of an error in an operation or application program interface (API) call in a large, distributed environment that can have various interacting services and components provided by one or more entities or providers. Approaches in accordance with various embodiments can overcome these and other deficiencies in conventional approaches by utilizing log sequence monitoring in such an environment. In at least some embodiments, a cloud administrator or other such entity can use the log sequence monitoring tools and/or data to quickly pinpoint the root cause or causes of a problem. Once the root cause has been determined, the administrator (or other appropriate person, system, process, or entity) can take appropriate remedial action on the faulty component, service, or other such system related causes.

In some embodiments, system logs can be used to track the progress of events within distributed systems and to identify a source of a problem with one or more services. For example, log messages can be used to identify the source of the log message within the system. Further, a sequential order of log messages with time stamp information may be used to identify those processes that were successfully initiated and/or completed within the system. Accordingly, the source and sequential order of log messages while providing a service and/or processing an API call can be used to identify potential problems within one or more services. In various embodiments, sequences of events related to one or more API calls may be determined and information associated with these calls may be stored. The calls can be identified at least in part by assigning them unique identifiers (e.g., alphanumeric character strings). As a result, a sequence of expected log messages for each API call or operation completed by one or more related services can be stored and then compared with the actual log sequence in order to detect anomalies within one or more services or systems. If differences are discovered between a reference sequence of log messages for a service and the actual stored log message sequence, an anomaly can be reported to an administrator and a graphical representation of related service events related to the anomaly may be generated to assist an administrator in identifying the source of the anomaly.

Accordingly, in various embodiments, system event logs can be leveraged for log mining and anomaly detection. Embodiments can reduce the operational time to troubleshoot problems which enhances the availability of a cloud or other API based operations. Further, embodiments may quickly point an administrator to the systems and services where an error was experienced to allow for targeted troubleshooting. Additionally, embodiments provide a feedback mechanism for the complex interaction of multiple services and distributed systems. Accordingly, a cloud system and administrators can learn from mistakes depending on the inputs provided to the system from the various systems and update reference sequences to identify previously unknown relationships and interconnections between systems and/or services.

An approach in accordance with various embodiments can be performed and/or referenced with respect to a set of sequential phases. In a definition phase or initialization phase, records are pre-populated with unique message signatures and assigned corresponding state identifiers. For each API call, one or more of the log messages can be tagged with at least a start tag and at least one end tag. A sequence or set of log messages can be generated per service, per API call, per operation step of a service, or as otherwise appropriate. In an identification phase or detection phase, the knowledge of the environment and other such information can be used to detect any anomalies. For each API call made by the system, the incoming log messages can be compared with the reference sequence for that API call. Any errors or deviations can be reported as appropriate, and the information used to improve future determinations of anomalies. Such an approach has various benefits, such as reducing the operational time and effort needed to troubleshoot problems. Such a process can help to quickly point to the nearest areas and services where an error may have originated. The system can learn from misidentified errors as well as add new log message sequences to avoid future mistakes.

Such an approach can be implemented as a standalone component or as part of an operational support system, among other such options. The implementation can be a software- and/or hardware-based solution with options to be operated from locations such as a public cloud, a private cloud, or a classic IT-based environment. The approaches can be used with private and public cloud operating systems or any software that uses APIs to cause tasks or action to be performed using calls such as create, read, update, and delete, among others.

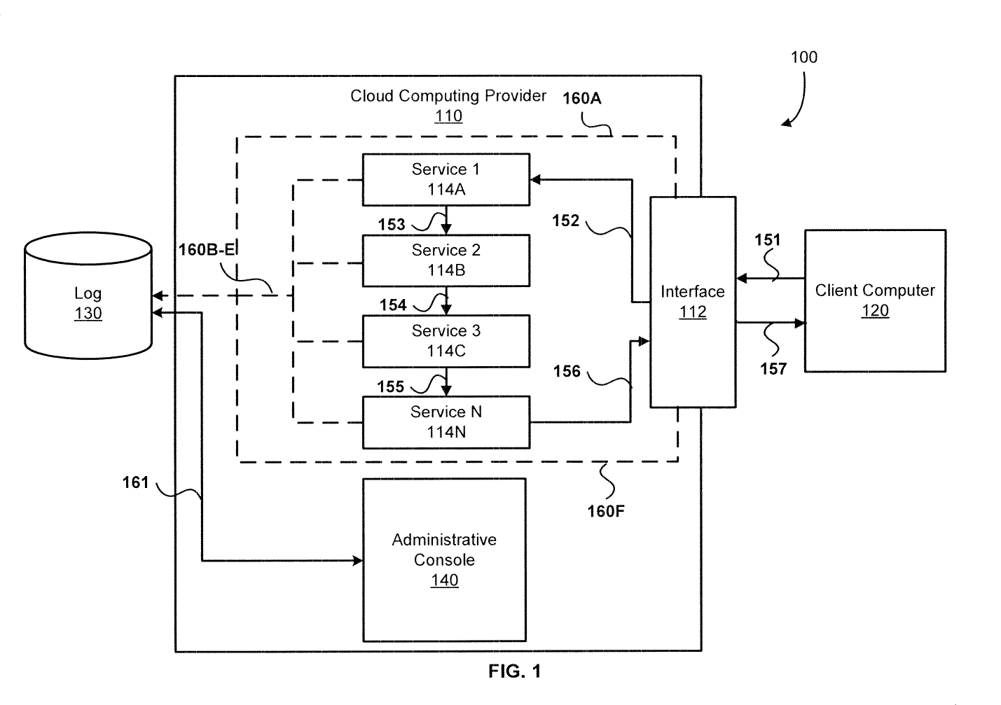

FIG. 1 illustrates an example block diagram of a system 100 for anomaly detection within a cloud computing provider 110 in accordance with various embodiments. The system 100 for anomaly detection includes a client computer 120, a cloud computing provider 110 including an interface 112 (e.g., an API) and a variety of services 114A-114N associated with an operation or operations associated with the interface 112. Additionally, the system 100 for anomaly detection may include a log 130 associated with the cloud computing provider 110 and an administrator console 140 associated with the cloud computing provider 110.

A client computer 120 may include any computing device configured to send and receive messages over one or more communication networks. For example, the client computer may include a desktop, a smartphone, a tablet, a laptop, a wearable device (e.g., watch, glasses, etc.), or any other device with a processor, memory, and communication components.

A cloud computing provider 110 may include an interface 112 (e.g., an API) and a variety of services 114A-114N associated with an operation or operations associated with the interface 112. The services 114A-1114N may include any type of processing, operations, or series of steps that manipulate or process data. The services may include multiple processing steps, calls to other services, or may include a single step or operation. The services may be provided by a single computer system or may be provided across multiple different computing systems or system resources. As should be understood, each service can include one or more computing components, such as at least one server, as well as other components known for providing services, as may include one or more APIs, data storage, and other appropriate hardware and software components.

FIG. 1 illustrates an example environment 100 in which the anomaly detection system may be implemented in accordance with various embodiments. In this example, a user of a client computing device 120 submits a request 151 or other command associated with an interface 112 (e.g., API) of the cloud computing provider 110 over one or more communication networks to the cloud computing provider 110. The API request 151 can be transmitted from the client computing device 120 across at least one appropriate network (not shown) to initiate one or more services 114A-N associated with the API request 151. The network (not shown) can be any appropriate network, such as the Internet, a local area network (LAN), a cellular network, and the like. The request 151 can be sent to an appropriate cloud computing provider 110 that is configured to provide one or more services, systems, or applications for processing such requests 151. The information can be sent by streaming, uploading, or otherwise transferring the information using at least one appropriate communication channel.

In this example, the request 151 is received at an interface 112 of the cloud computing provider 110. The interface 112 can include any appropriate components known or used to receive requests from across a network, such as may include one or more application program interfaces (APIs) or other such interfaces for receiving such requests 151. The interface 112 might be operated by the provider, or leveraged by the provider as part of a shared resource or “cloud” offering. The interface 112 can receive and analyze the request, and cause at least a portion of the information in the request to be directed to an appropriate system or service, such as one of the various services provided by the cloud computing provider 110.

For example, the cloud computing provider 110 may provide any number of different services 114A-114N through a variety of different computer systems. Thus, the interface 112 may determine the type of request or instruction from the client computer 120 based on the interface receiving the request and may determine which of one or more services should be called in response to the API request 151. Accordingly, as shown in FIG. 1, the interface 112 determines that the request 151 is associated with service 1 114A and an API call 152 is sent from the interface 112 to service 1 114A to initiate the processing of service 1 114A. The various services 114A-114N provided through the cloud computing provider 110 may be interrelated such that various services may be called in a sequence or may rely on the processing of other services in order to process one or more requests. For example, as shown in FIG. 1, service 1 114A through service N 114N may be related such that service 1 may perform one or more operations and then call 153 Service 2 114B which performs additional operations and once completed may call 154 Service 3 114C and so forth. Although the relationships between services shown in FIG. 1 are linear between services, in some embodiments, the relationships between services may be complicated and difficult to identify. Accordingly, it may be difficult to identify services or components that lead to an error in one or more services associated with an API request or other operation.

Accordingly, in some embodiments, each of the services 114A-N as well as the interface 112 may generate and submit log messages 160A-160F in response to one or more events occurring at the interface or service. The event may include one or more operations, processes, or other actions being performed by one or more computer systems of the cloud computing provider 110. For example, an event may include sending or receiving a service call, initialization of one or more operations or processes at one or more computers associated with a service, completion of one or more operations or processes at one or more computers associated with a service, and/or any other identifiable occurrence, time, or operation associated with the service. For instance, an event may include initialization of a single operation or any number of different operations by a service. Further, an event may include completion of one or more operations associated with one or more services. A logger or other logging module may be incorporated into each service or computers associated with a service that may generate a log message upon the occurrence of the predetermined event. The events may be implemented at any relevant abstraction layer of the service such that a log message is generated upon completion of multiple steps within a service or across multiple services. Alternatively or additionally, a separate log message may be generated upon completion of each step within a service or across multiple services.

The log messages may utilize an appropriate architectural style, such as the Representational State Transfer (REST) style often used with Web services. Many REST-based applications expose the API flows for their usage and provide a valid HTTP response to denote its success or failure. Further, the log messages may include log message signatures that identify which service is providing the log message, which step is being performed by the service, and any other information associated with a service, resource, or other component originating the log message. In some embodiments, the log message signatures may be unique for each service and/or step, process, or operation of a service associated with the event.

A log 130 associated with the cloud computing provider 110 may include any data store or storage system configured to receive and store log messages from one or more services, cloud computing providers, and/or components of a system. The log may store time stamps, data associated with a log message, an identifier associated with the sender of the log message, and/or any other information associated with the cloud computing provider and/or system that generated the log message. The log may be operated by the cloud computing provider or may be external to the cloud computing provider. The log may interface with multiple cloud computing providers or systems within a single cloud computing provider. Additionally, in some embodiments, multiple separate logs may be used to store log messages from different systems. Accordingly, although a single log is shown in FIG. 1, in some embodiments any number of different logs may be implemented.

FIG. 1 illustrates an example of one API request flow that can be utilized in accordance with various embodiments. Such an approach can vary as per the different logging levels that been used in production, as well as other factors as may include the density and quality of log messages in the code base. Accordingly, the log messages may be generated in response to events that are the result of a step or process within a service, the completion of multiple steps or processes within a service, successful completion of a service, or the completion of multiple services across multiple systems. Thus, although embodiments described herein may focus on events as a result of the operation of a single service, event notifications and tracking of activities may be performed at any appropriate or desired event logging level.

In the example shown in FIG. 1, log messages 160A-160F may be generated in response to events associated with the interface and the various services being called in response to the API request. For example, log messages 160A-160F (shown as dotted lines in FIG. 1) may be generated and sent to the log when the interface receives an API request 160A, upon service requests received at the various services 160B-160E, and in response to completion of the processing of the API request and transmission of an API response 160F. For instance, in response to the interface receiving the API request 151, a logger within the interface 112 generates a log message 160A including a log signature associated with the API request being received and sends the log message 160A to the log 130. The interface 112 makes a call 152 to Service 1 114A to perform an operation in response to the API request 151, and upon Service 1 receiving the call 152, Service 1 114A may generate and send a log message 160B having a log signature associated with Service 1 114A to the log 130. Service 1 114A may call 153 or otherwise send an operation request to Service 2 114B and upon Service 2 114B receiving the call 153, Service 2 114B generates and sends a log message 160C to the log 130. This process may be repeated for Service 3 114C and Service N 114N with corresponding log messages 160D-160E being generated and sent to the log 130 with corresponding log signatures associated with each of the respective services in the respective log signatures. Service N may send a response call 156 to the interface 112 which may then send a response 157 (e.g., API response) to the client computer 120. The interface 112 may generate and send a log message 160F in response to receiving the call 156 from Service N 114N. Accordingly, the log 130 includes log messages associated with each of the services and/or steps associated with an API request and the log messages are received sequentially with time stamps and log signatures indicating which services were called and when the services were called. Thus, the log may include a sequence of log messages that can be used to identify which services were called, in what order, and at what time each service was called.

An administrator console 140 associated with the cloud computing provider 110 may include a service implemented on any computer or system associated with a system operator, administrator, or engineer of the cloud computing provider. The administrator console 140 may allow the user to obtain system information about the cloud computing provider including providing access to the log 130. In embodiments with multiple logs (not shown), the administrative console may have access to each of the multiple logs (not shown). The administrative console may be configured to access log messages from the log by sending a log message request and receiving a log message response including the log messages stored in the log over a particular time period, log messages associated with a particular command or service, and/or all of the log messages within the log. In some embodiments, the administrative console may be configured to communicate 161 with the log through any suitable communications network (not shown). In some embodiments, the log may be stored locally to a particular administrative computer or system (not shown).

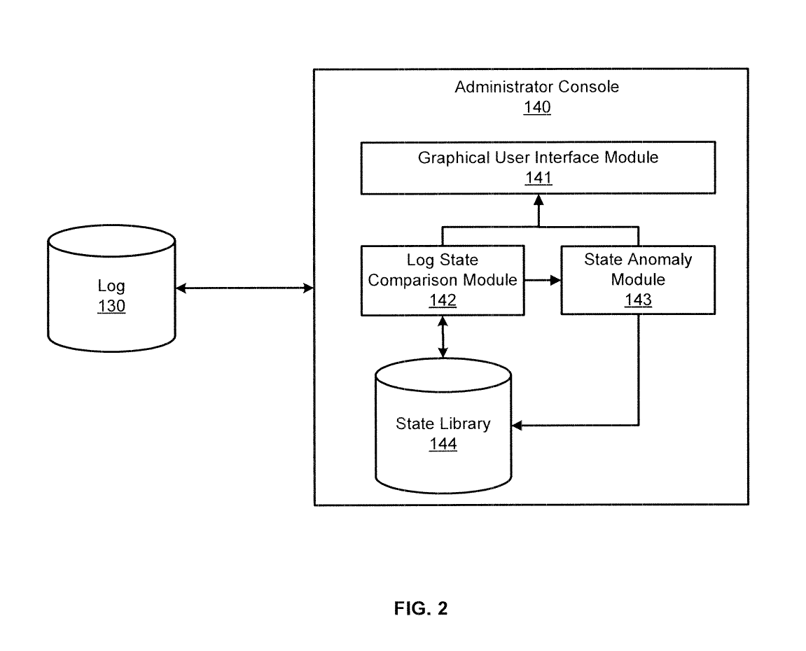

FIG. 2 illustrates an example of a portion of the anomaly detection system of FIG. 1 showing the interaction between the administrator console 140 and the log 130. The administrator console may include a graphical user interface module 141, a log state comparison module 142, a state anomaly module 143, and a state library 144. In an example embodiment of the present invention, the log may be pre-populated with log messages by one or more services of a cloud computing provider. The log messages may include a variety of log message signatures that can be assigned state identifiers during an initialization phase by the administrator console. The state identifiers may be unique for each log signature associated with one or more services such that a state identifier may indicate to the administrator console the specific service, device, and type of event associated with a log message. The unique identifiers can be used to record and pre-populate the chain of events or phases and identify a successful API call for one or more services provided by one or more cloud computing providers.

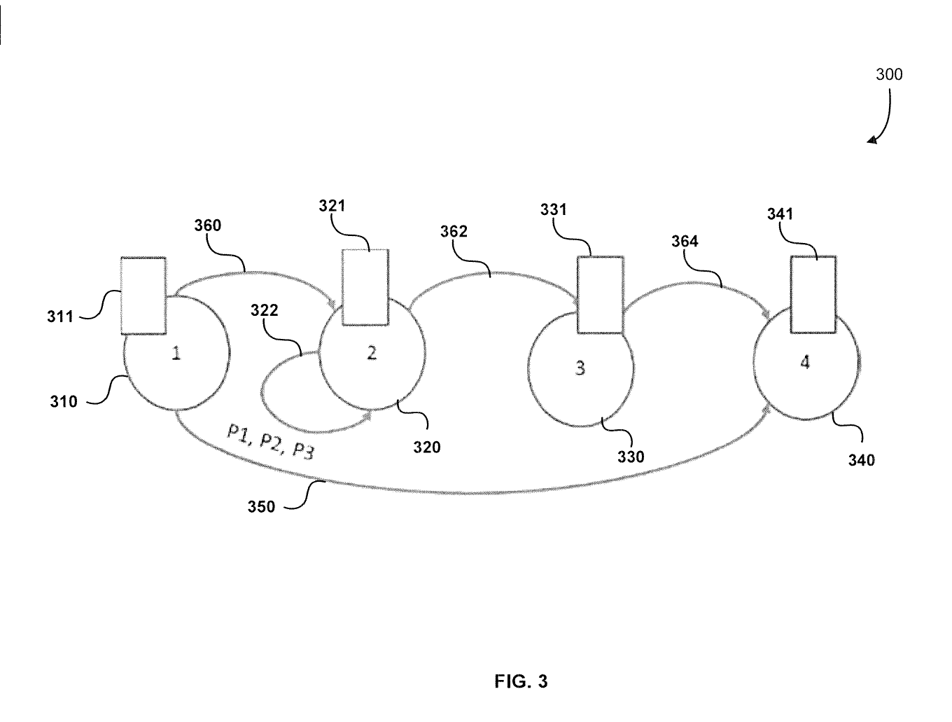

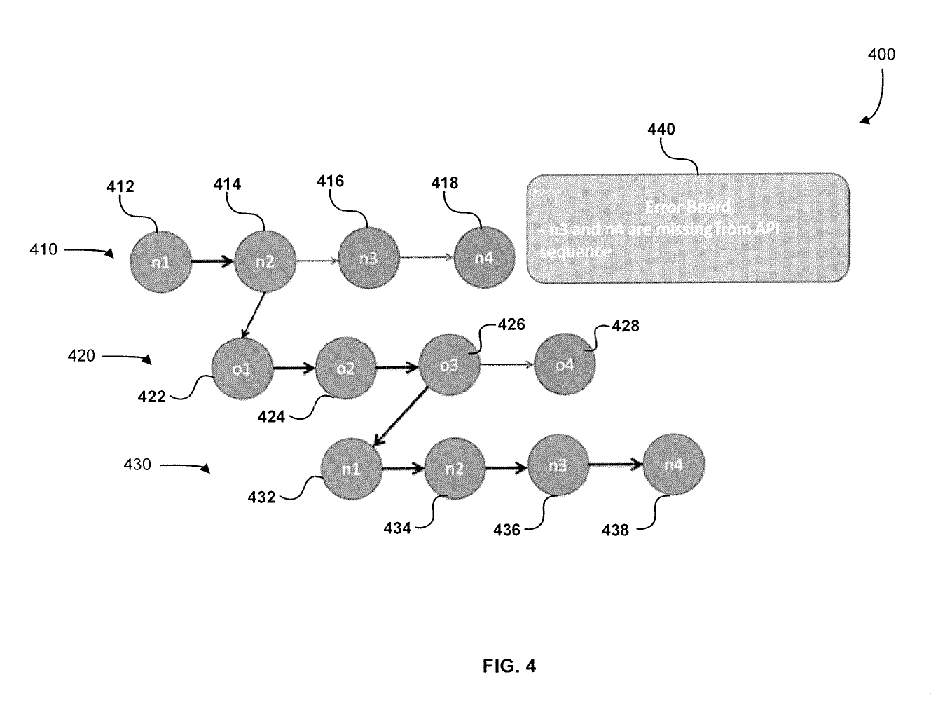

The graphical user interface module 141 may include a software module configured to generate a graphical representation of a sequence of events or states of one or more services associated with an API call, according to the description of embodiments described herein. The graphical representations may include any of the information stored or derived as a result of the log message mapping and interpretation described herein. The graphical representations may indicate anomalies detected between reference sequences of events and actual log messages from a system and may display the anomalies and the operation of one or more services in an intuitive and user-friendly format. For example, FIGS. 3-4 show example graphical representations of different sequences of log messages associated with one or more services. These are merely examples and many different types of graphical displays of the relevant information may be generated and presented, as one of ordinary skill would recognize. The graphical user interface module may cause the generated graphical representations of information to be displayed to a user of the administrator console through any suitable display, monitor, screen, or other component configured to display information. The graphical user interface module may receive information from the log state comparison module, the state anomaly module, and/or both modules depending on the results of an anomaly detection process.

The log state comparison module 142 may include a software module configured to analyze log messages from the log to compare the log messages to predefined sequences of expected log messages in a reference state library to detect anomalies and determine the possible sources of anomalies in the operation of one or more systems. For example, the log state comparison module may be configured to analyze a message log for log signatures corresponding to state identifiers associated with the one or more services, map the log signatures to the state identifiers, compare the state identifiers to at least one reference sequence of state identifiers associated with the one or more services, and identify one or more differences between the at least one reference sequence of state identifiers associated with the one or more services and the state identifiers.

The state anomaly module 143 may include a software module configured to notify an administrator when an anomaly is identified and provide error parameters associated with the anomaly to assist an administrator in identifying the root cause of an anomaly. The state anomaly module may receive an indication of an anomaly from the log state comparison module and may obtain error parameters associated with the last successful state of the API to identify potential root causes for the anomaly. For example, the state anomaly module may collect potential error parameters or other sources of error associated with the differences identified by the log state comparison module, generate a notification based on the one or more differences between the at least one reference sequence and the state identifiers, and provide information to the graphical user interface module that can be used to provide a graphical presentation of the source of the errors in a API request or other operation of the system. Further, in some embodiments, the state anomaly module may update the state library with new sequences of state identifiers for discovered system interactions that are not errors or new error parameters associated with particular state identifiers. Accordingly, the system can learn from anomalies discovered during operation and can update the reference state library in response to actual log messages and results of API calls. In some embodiments, approval from an administrator may be obtained before updating the state library. Alternatively or additionally, in some embodiments, the anomaly detection system may update the state library automatically as new sequences of state identifiers, API events, and interactions between services and systems are identified.

In some embodiments, the log state comparison module 142 and the state anomaly module 143 may be referred to collectively as an anomaly detection module (not shown) which may be configured to analyze a plurality of log messages from the log for log signatures corresponding to state identifiers associated with the one or more services, map the log signatures to the state identifiers, compare the state identifiers to a plurality of reference sequences of state identifiers associated with the one or more services stored in a reference sequence library, and identify at least one reference sequence of state identifiers from the plurality of reference sequences of state identifiers in the reference sequence library that is associated with the state identifiers. The anomaly detection module (not shown) may further be configured to detect an anomaly by identifying one or more differences between the at least one reference sequence of state identifiers associated with the one or more services and the state identifiers and automatically update the reference sequence library to include a new reference sequence of state identifiers based on the one or more differences between the at least one reference sequence and the state identifiers. Additionally, the anomaly detection module (not shown) may be configured to generate a notification including an indication of the anomaly and the one or more differences where the notification may include a graphical representation of the state identifiers that are present in the message log and the one or more differences between the at least one reference sequence and the state identifiers. Moreover, the anomaly detection module may identify one or more error parameters associated with the one or more differences between the at least one reference sequence and the state identifiers, where the error parameters identify the one or more services that are associated with the one or more differences.

The state library 144 may include a data store or other reference data that identifies the relationships between log signatures of the services and assigned state identifiers of the anomaly detection system, reference sequences of state identifiers associated with registered API calls or other services provided through the cloud computing provider, error parameters associated with the states or API calls of services, and any other relevant information collected and monitored through embodiments of the invention. The state library may store reference sequences of state identifiers associated with individual API calls of systems and/or services provided by the cloud computing provider. Each event within the reference sequences of events of the API calls are assigned unique state identifiers that are mapped to particular log signatures generated by each of the services (or specific steps within each service) of the cloud computing provider. As a result, a reference sequence of state identifiers for each API call is stored in the state library that can then be compared with an actual log sequence generated in response to operation of the services for anomaly detection. REST based software exposes API flows of services as they operate and provides a valid HTTP response to denote an API calls success or failure. Accordingly, embodiments may pre-populate all log message signatures of the services and assign them a unique state identifier. Using these state identifiers, sequences or chains of events (or phrases) can be identified and stored for successful API calls in the state library. Thus, the reference successful call sequence can be compared to actually received log messages to identify whether a system is operating as expected, leading to successful API calls. Further, because the expected operation is compared, specific events can be identified as missing, leading to identification of which services, steps, or systems are most likely the root cause of an unsuccessful API call. The state library may store reference sequences of state identifiers according to any relevant organizational manner. For example, the reference sequences of state identifiers may be stored by API identifier, state identifier indicated as a start tag or an end tag, state identifier, error parameters associated with a state identifier, or any other suitable information associated with the reference sequences of state identifiers.

FIG. 3 illustrates an example graphical representation 300 of sequences of events (also referred to as chains of events) for an API call that can be utilized in accordance with various embodiments. The graphical representation of the possible sequences of events for the API call include a graphical representation of state identifiers 310-340 associated with different API states, error parameters 311-341 associated with each of the respective state identifiers 310-340, a first sequence 350 of state identifiers for a successful API call, and a second sequence 360-364 of state identifiers for a successful API call 300. An API call may have any number of different sequences of state identifiers for a successful call depending on the conditions associated with an API call, the number of different states within the API, and the abstraction level of the log messages associated with each of the processes associated with an API call. The sequences of state identifiers can identify the various relationships between API states within a system and can provide valuable information for identifying sources of anomalies within a system or API call.

For example, for the API call shown in FIG. 3, the API call has two possible successful sequences of states for the API. Each of the state identifiers indicates a particular API event or operational state for the API call. When the service reaches the particular state triggering an event, the corresponding log message is sent to the log. An event represents a particular activity of the corresponding service. The event may also be referred to as a state or an operational state. A sequence of graph nodes can be used to represent the sequence of state identifiers in a log file interconnected with each API event. A sequence is reflected by arrows showing which state identifier will come after a preceding sequence of state identifiers. Through a service graph, an optional sequence of events can also be represented. For example, for the API call shown in the service graph of FIG. 3, there are two different sequences of state identifiers for the API call. For instance, after state identifier 1 310, state identifier 2 320, state identifier 3 330, and state identifier 4 340 can occur. Alternatively, state identifier 1 can be followed by state identifier 4 340. Displaying alternative sequences of state identifiers is particularly helpful in identifying service behaviors where multiple options can be specified with a single API call. Thus, for example, an API call can be made with varying levels of options resulting in different events being triggered and different state identifiers being generated in different sequences, that can be displayed in a single service graph (as shown in FIG. 3).

Additionally, log messages often contain status messages of various components which are triggered periodically and that may have nothing to do with the operations being carried out. In the process of verification of logs messages against service policy graphs, these noise messages can create discrepancies for actual operation call monitoring. Accordingly, these log messages may be represented as noise calls 322 in a particular event or state. For example, at state identifier 2 320, three periodic messages P1, P2 and P3 can come in any order before or after the state identifier 2 320 is reached. Thus, the three periodic log messages are shown as calling the same state identifier 320. In order to make the anomaly detection more concrete, these periodic log messages can be represented with special state identifiers 322 that do not affect the sequence of state identifiers.

Moreover, each state in a graph may have particular semantics or parameters 311-341 associated with the respective state identifier. Thus, its absence or presence means a particular situation for the monitoring system. Thus, the graph can associate a number of error parameters or potential reasons for failure associated with each state identifier. It is quite possible that a state in a particular service graph is absent because of another service problem or error. Therefore, it can be advantageous to associate a set of reasons with each state identifier (and corresponding API state) as to the possible set of reasons if a particular event is absent. As shown in the graph of FIG. 3, state identifier 1 310 can have a number of properties 311 associated with it, for example, failure_reasons={“S2:4”, “S4:3” } which means that the failure reasons or absence of state identifier 1 in an example service S1 can be a 4th state of Service 2 and/or a 3rd state of Service 4. Accordingly, the state anomaly module may identify the error parameters associated with a particular missing state when an anomaly is identified and may present the error parameters to an administrator to assist in trouble shooting anomalies.

FIG. 4 illustrates an example graphical display of a chain of events across multiple services that shows the interaction of multiple services and an anomaly detected across one or more of the services in accordance with various embodiments. In distributed systems, where a single log file is maintained for a variety of services, it is quite possible that a standard logger writes all the log files to a single location. In such a case, based on the individual service policy graphs associated with each of the APIs or services, a number of policy patterns can be extracted and on the basis of timestamps, their failure can be monitored against the actual log messages of the distributed system. Every log file represents a sequence of steps that are reflected after an API call is being initiated. In some embodiments, these reference sequence patterns and/or individual steps may be assigned high level error parameters that can assist an administrator in understanding the cause of failure in the case of an incident, anomaly, or missing sequence of expected state identifiers.

Accordingly, in the event of a failure or anomaly in distributed systems, embodiments may display identified API call sequences and corresponding present and missing state identifiers of the various API calls across multiple services to provide an overview of different services that may have participated in the failure or anomaly. Accordingly, timestamps may be used to take other service sequences into account when an anomaly or failure occurs. Thus, a time of the failure may be identified and reference sequences of related services may be displayed together based on the time of the failure. One example of such a multiple service based graph is shown in FIG. 4.

As can be seen in FIG. 4, each of the state identifiers associated with three different services 410-430 that are interrelated are shown in response to the identification of an anomaly in a first API call 410. The state identifiers associated with each of the APIs (which can also referred to as separate services herein) are displayed in different colors to indicate whether a state identifier is present in the log (e.g., blue if present and red if not). Accordingly, the first state identifier 412 and second state identifier 414 of the first service are present in the log (as indicated by the blue color of those state identifiers) while the third state identifier 416 and fourth state identifier 418 of the first service 410 are missing from the log (as indicated by the red color of those state identifiers). Accordingly, there are differences between the reference sequence of state identifiers expected for the service 410 and the actual recorded log messages within the log once the service has been executed. Further, an error notification 440 is displayed for an administrator indicating that state identifiers 416 and 418 are missing from the first service 410.

Additionally, the relationships between the services 410-430 are indicated in the multiple service graph display 400. For instance, the second state identifier 414 of the first service 410 is shown as being related to the first state identifier 422 of the second service 420. This is indicative of the second state (corresponding to the second state identifier 414) of the first service 410 calling the second service 420. Further, as can be seen in the multiple service graph 400, the fourth state identifier 428 of the second service 420 is also missing from an expected reference sequence of state identifiers associated with the second service 420 (as indicated by the red color). However, even though the first service 410 and the second service 420 are missing state identifiers (e.g., state identifiers 416, 418, and 428), the third service 430 operates correctly and there are no anomalies associated with the third service 430 (as indicated by all four of the expected state identifiers 432-438 of the third service 430 being present and being colored blue). Accordingly, the multiple service graph 400 provides an administrator a large amount of information regarding the interrelated nature of the various services 410-430 and how an error in one service may or may not affect the performance of other services in a quick and intuitive manner.

Further, the multiple service graph 400 may provide error parameters associated with the second state identifier 414 of the first service 410 and the third state identifier 426 of the second service 420 that allows the administrator to identify the possible conditions that led to the next state identifier for each of the services not being present in the log. For instance, the error parameters may indicate that the third state identifier 416 associated with the first service 410 may not perform correctly when a third state of service 5 (not shown) does not perform correctly, when a piece of data stored in memory at one of the systems operating service 1 is not able to obtained, or any other information related to the state that may cause an error. Accordingly, an administrator can user the multiple service graph display to quickly and easily see which events were triggered and were not triggered in the various services, the relationships between various services, and can quickly hone in on the possible sources of an anomaly when an event is not triggered for one or more services.

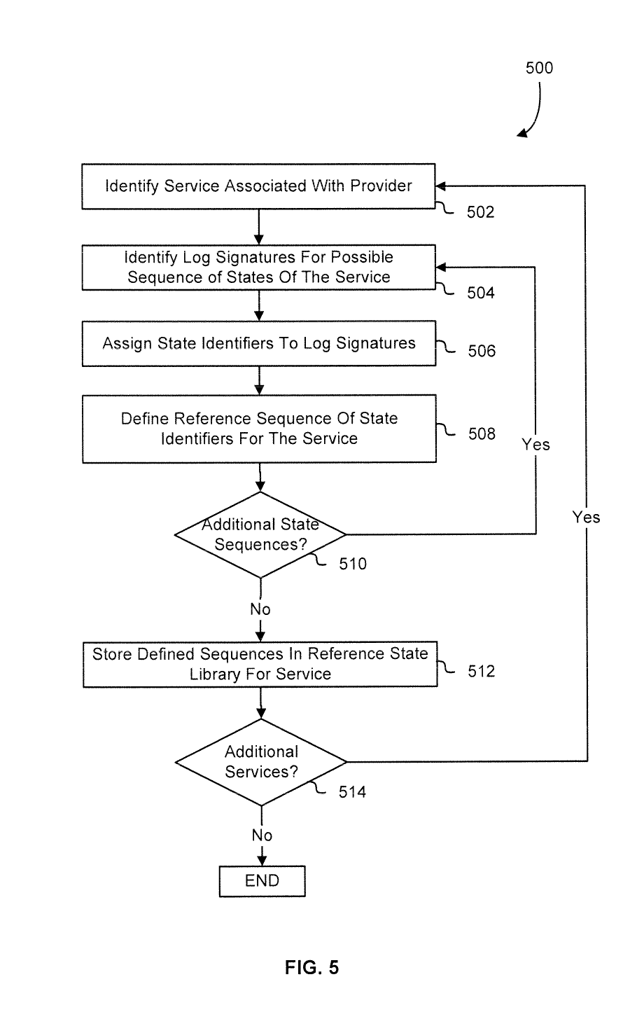

FIG. 5 illustrates an example flow chart of a process 500 for registering a service with an anomaly detection system in accordance with various embodiments. The process 500 may be performed by a system administrator, engineer, or other operator of a cloud computing provider that can identify the potential events associated with one or more services. The process may be performed manually by an operator or a map of log signatures of log messages and corresponding state identifiers may be uploaded to a system for automatic mapping of the various services provided through a system.

At step 502, a service associated with a cloud computing provider may be identified. For example, log messages from a log may be analyzed to identify which services are logging events in the log and the sequence of such events within the log. In some embodiments, the system architecture may be defined and provided such that the various services and their corresponding events may be identified without analyzing a log.

At step 504, a log signature is identified for each event within a set of events associated with the service. For example, the log may be analyzed to identify the various signatures that are present and compared to the service being called to identify particular log signatures associated with each event or state of a service. In some embodiments, the log signatures may be provided in a system architecture overview and analysis of the log may not be necessary. Each event where a log message is generated and sent in response to the initialization or completion of a service call, API call, or other operation may have an associated log signature that is identified. Each event may be associated with a state of the service where the service has one or more possible ordered sequences of states that indicate successful completion or call of a service.

At step 506, a state identifier may be assigned for each log signature for each event within the set of events. Accordingly, no changes to the log signatures generated by the various events or operational states of the service are changed, although that is possible in some embodiments. Instead, the log signatures are identified as being mapped to a particular state identifier that is associated with a particular service within a state library. Additionally, in some embodiments, error parameters, conditions, and any other relevant information can be stored in a reference state table data store along with the assigned state identifier. The assigned state identifiers may be unique for each event of each service.

At step 508, a reference sequence of state identifiers is defined for each of the one or more ordered sequences of events for the service. A sequence of events associated with each service may be defined and the corresponding state identifiers of the events may be stored in a sequence for the service.

At step 510, any other potential sequences of events may be identified for the service. For example, the log may be analyzed for other sequences of events that lead to successful completion of the service call. For example, as described in reference to FIG. 3, the service has two sequences for successfully completing the service. If the log includes different possible sequences for successfully completing a service call, the process may return to step 504 described above related to identifying the log signatures associated with the sequence of events for the service.

At step 512, once all of the sequences are identified for the service, the reference sequences of state identifiers for each of the one or more ordered sequences of state identifiers may be stored in a reference state library.

At step 514, additional services provided by the cloud computing provider may be identified and if so, steps 502-512 may be repeated for each of the other services until reference sequences for all of the possible sequences of events have been defined. Accordingly, all services and possible sequences of successfully completing the services may be identified and defined for the cloud computing provider.

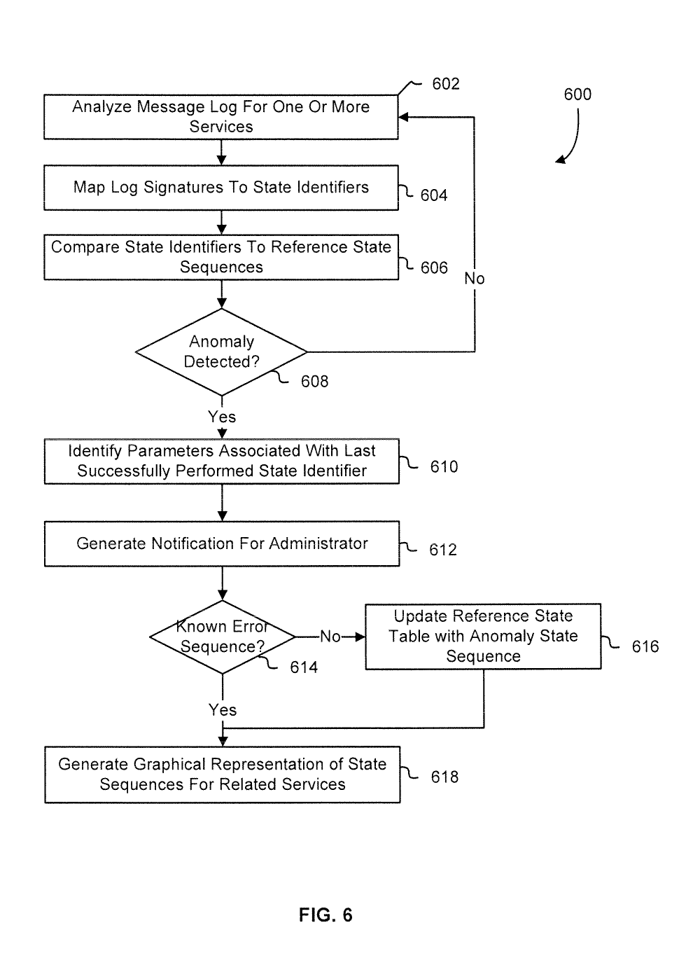

FIG. 6 illustrates an example flow chart of a process 600 for detecting an anomaly associated with one or more services. The anomaly detection system may include a log including log messages associated with one or more services provided by one or more computing systems or cloud computing providers. Each log message within the message log may previously be generated in response to an event by the one or more services. Each of the log messages may include a log signature, a time stamp, and any other relevant information associated with the event.

At step 602, a message log is received by an administrative console and analyzed for log signatures corresponding to state identifiers associated with the one or more services. A look up table may be searched or other mapping reference may be used to identify log signatures that are defined within the anomaly detection system.

At step 604, the log signatures may be mapped to predefined state identifiers. The state identifiers may be stored in the state library or other look up table. In some embodiments, the mapping may be accomplished through any suitable identification and altering of the log messages such that the log signatures are transformed into the predefined state identifiers. In some embodiments, the system may not alter the log messages and may merely interpret the log signatures as corresponding to the predefined state identifiers.

At step 606, the state identifiers may be comparing to at least one reference sequence of state identifiers associated with the one or more services. The reference sequences may be stored in a state library associated with the cloud computing provider or the service. Any suitable method for looking up and comparing the reference sequences may be used. For example, the system may identify a state identifier associated with a start tag and compare each state identifier within the stored possible sequences of state identifiers to compare each possible state identifier associated with the start tag. Further, in some embodiments, each of the state identifiers may be compared piece-meal to the reference sequences of state identifiers stored in the state library. Any other suitable method may be used as would be recognized by one or ordinary skill.

At step 608, it is determined whether an anomaly is present or if each of the state identifiers in the log match one of the possible reference sequences associated with a service. An anomaly may be detected where one or more differences are found between the at least one reference sequence of state identifiers associated with the service and the sequence of state identifiers from the log. If no anomaly is detected, the system may wait for the next service to operate, the next periodic running of the anomaly detection process, or may identify the next log update for continual anomaly detection.

At step 610, where an anomaly is detected, one or more error parameters associated with the one or more differences between the at least one reference sequence and the state identifiers may be identified in order to provide a system administrator as much information as possible regarding the possible source of the anomaly. For example, the last successfully accomplished event from the sequence of state identifiers may be identified and error parameters associated with the state identifier associated with that event may be identified within the state library (or from another data store including the error parameters).

At step 612, a notification related to the detected anomaly may be generated and sent or displayed to a system administrator. In some embodiments, the error parameters may be included in the notification or may be linked to the notification such that the error parameters may be presented upon the administrator interacting with the notification. Accordingly, the error parameters may be displayed to the system administrator showing the possible sources of the error. Where the system can rule out potential sources of error, those error parameters may be removed from the notification. For example, if the error parameters list a potential service call as causing the problem but the service was successfully completed and/or the error parameter is otherwise not relevant to the present error, that potential cause could be removed from the information presented to the system administrator. The notification may include the one or more differences between the at least one reference sequence and the state identifiers. Any suitable method of displaying this information may be completed.

At step 614, the differences between the reference sequence of state identifiers and the actual log of event identifiers may be analyzed to determine whether the error sequence has been previously identified as a problem with the system. For example, error sequences may be logged whenever an anomaly is detected by the system and can be presented to an administrator to determine whether the sequence is not an error and whether it should be added to the state library as a potentially successful calling of a service.

At step 616, if the error sequence has not been previously identified, the at least one reference sequence of state identifiers stored in the state library as being associated with the service may be updated to include a new reference sequence of state identifiers including the differences between the at least one reference sequence and the state identifiers. Accordingly, the state library may be continually updated to include the actual operation states and events associated with the operation of the various services. In some embodiments, an administrator may be asked before updating the state library. Alternatively or additionally, the state library may be updated automatically without asking for permission by the system administrator.

At step 618, a graphical representation of the sequence of state identifiers that are present in the message log may be generated and displayed. The graphical representation may include the one or more differences between the at least one reference sequence and the state identifiers such that an administrator can quickly and easily identify the source of the anomaly as discussed above in reference to FIGS. 3 and 4. Further, as discussed above in reference to FIG. 4, the graphical representation may include state identifiers that are present in the message log for related services to the one or more services such that the administrator can obtain information about related services to the service in which the anomaly occurred. Further, a time stamp of the last successful event may be used to hone in on the various related services and events prior and after that time stamp may be presented in the graphical representation.

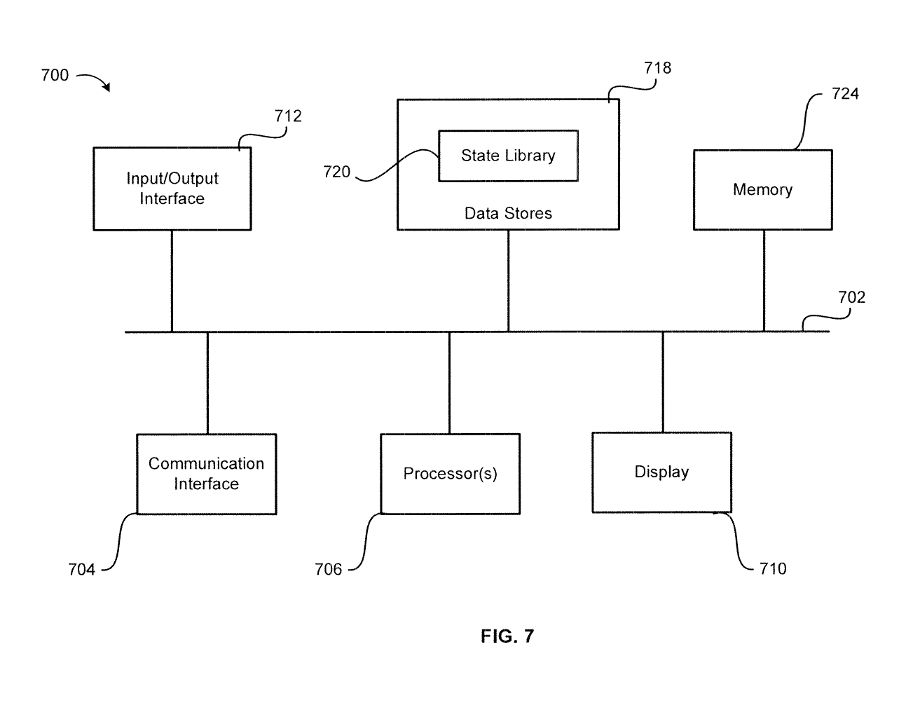

FIG. 7 illustrates a set of basic components of an example computing device 700 that can be utilized to implement aspects of the various embodiments. In this example, the device 700 includes at least one processor 706 for executing instructions that can be stored in a memory device or element 724. As would be apparent to one of ordinary skill in the art, the device 700 can include many types of memory, data storage or computer-readable media, such as a first data storage for program instructions for execution by the at least one processor 706, the same or separate storage can be used for images or data, a removable memory can be available for sharing information with other devices, and any number of communication approaches can be available for sharing with other devices. For example, the device 700 may be coupled to one or more data stores 718 including the state library 720 discussed herein. The device 700 may include at least one type of display element 710, such as a touch screen, electronic ink (e-ink), organic light emitting diode (OLED) or liquid crystal display (LCD), although devices such as servers might convey information via other means, such as through a system of lights and data transmissions. The device 700 typically will include a communication interface 704 that interfaces with or includes one or more networking components, such as a port, network interface card, or wireless transceiver that enables communication over at least one network. The device 700 can include an input/output interface 712 that may be used to interface with at least one input device able to receive conventional input from a user. This conventional input can include, for example, a push button, touch pad, touch screen, wheel, joystick, keyboard, mouse, trackball, keypad or any other such device or element whereby a user can input a command to the device 700. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

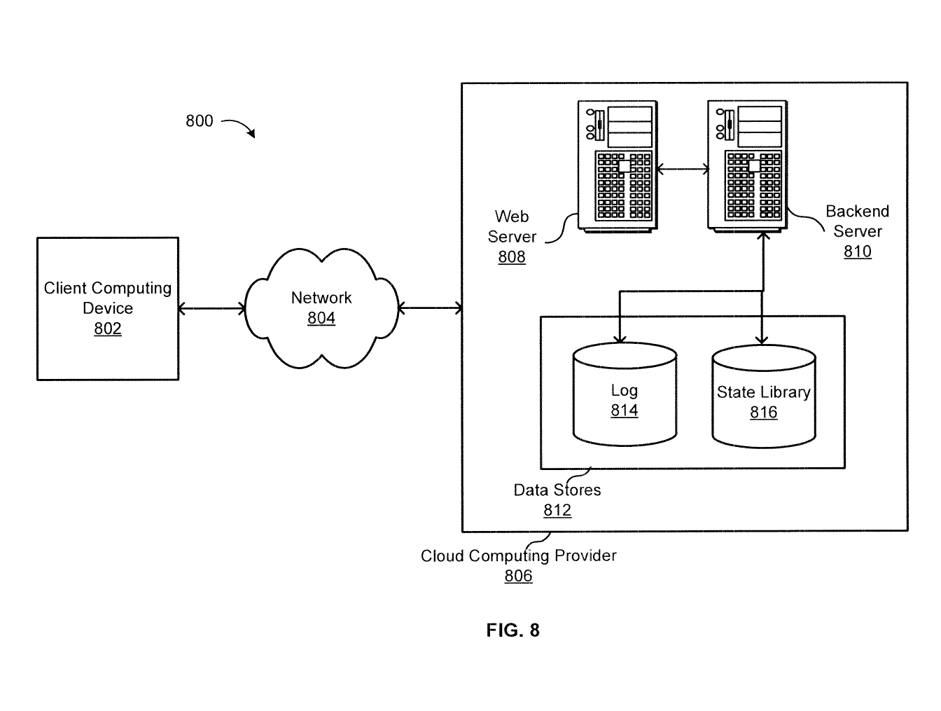

As discussed above, different approaches can be implemented in various environments in accordance with the described embodiments. As will be appreciated, although a Web-based environment is used for purposes of explanation in several examples presented herein in reference to FIGS. 1 and 2, different environments may be used, as appropriate, to implement various embodiments. Referring to FIG. 8, the environment 800 includes an electronic client computing device 802, which can include any appropriate device operable to send and receive requests, messages or information over an appropriate network and convey information back to a user of the device 802. Examples of such client computing devices 802 include personal computers, cell phones, handheld messaging devices, laptop computers, set-top boxes, personal data assistants, electronic book readers and the like. The network 804 can include any appropriate network, including an intranet, the Internet, a cellular network, a local area network or any other such network or combination thereof. Components used for such a system can depend at least in part upon the type of network and/or environment selected. Protocols and components for communicating via such a network 804 are well known and will not be discussed herein in detail. Communication over the network 804 can be enabled via wired or wireless connections and combinations thereof. In this example, the network 804 includes the Internet, as the environment includes a web server 808 for receiving requests and serving content in response thereto, although for other networks, an alternative device serving a similar purpose could be used, as would be apparent to one of ordinary skill in the art.

The illustrative environment 800 includes one or more services within a cloud computing provider 806 that can be provided by one or more backend servers 810 and data stores 812. It should be understood that there can be several backend servers, layers or other elements, processes or components, which may be configured to communicate, which can interact to perform tasks such as obtaining data from an appropriate data store, initiating other services, processing information and performing operations, and/or any other suitable functionality. As used herein, the term “data store” refers to any device or combination of devices capable of storing, accessing and retrieving data, which may include any combination and number of data servers, databases, data storage devices and data storage media, in any standard, distributed or clustered environment. For example, one or more data stores 812 may include the log 814 and state library 816. A backend server 810 can include any appropriate hardware and software for integrating with a data store 812 as needed to execute aspects of one or more applications or services for the client device 802 and handling a majority of the data access and logic for an application. The backend server 810 provides access control services in cooperation with the data store and is able to generate content such as text, graphics, audio and/or video to be transferred to the user, which may be served to the user by the web server 808 in the form of HTML, XML or another appropriate structured language in this example. The handling of all requests and responses, as well as the delivery of content between the client device and the backend server 810, can be handled by the web server 808. It should be understood that the Web and backend servers are not required and are merely example components, as structured code discussed herein can be executed on any appropriate device or host machine as discussed elsewhere herein.

The data stores 812 can include several separate data tables, databases or other data storage mechanisms and media for storing data relating to a particular aspect. For example, the data stores illustrated include mechanisms for storing a state library. The data stores are also shown to include a mechanism for storing log data. It should be understood that there can be many other aspects that may need to be stored in the data store, such as access rights information, user information, or any other relevant information to the services or applications being provided, which can be stored in any of the above listed mechanisms as appropriate or in additional mechanisms in the data store. The data stores 812 are operable, through logic associated therewith, to receive instructions from the backend server 810 and obtain, update or otherwise process data in response thereto.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a web server 808, the web server 808 can run any of a variety of server or mid-tier applications, including HTTP servers, FTP servers, CGI servers, data servers, Java servers and application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to one or more of the computers or remote from any or all of the computers across the network. In a particular set of embodiments, the information may reside in a storage-area network (SAN). Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computing system comprising:
at least one service module configured to:
determine that one or more events have occurred associated with one or more services of the computing system;
generate a log message associated with each of the one or more events, each log message having a log signature, the log signature identifying each of the one or more events and each of the one or more services; and
transmit the log message to a log associated with the computing system; and
an anomaly detection module configured to:
analyze a plurality of log messages from the log for log signatures corresponding to state identifiers associated with the one or more services;
map the log signatures to the state identifiers;
compare the state identifiers to a plurality of reference sequences of state identifiers associated with the one or more services stored in a reference sequence library;
identify at least one reference sequence of state identifiers from the plurality of reference sequences of state identifiers in the reference sequence library that is associated with the state identifiers;
detect an anomaly by identifying one or more differences between the at least one reference sequence of state identifiers associated with the one or more services and the state identifiers; and
automatically update the reference sequence library to include a new reference sequence of state identifiers based on the one or more differences between the at least one reference sequence and the state identifiers.

2. The system of claim 1, wherein the anomaly detection module is further configured to:
generate a notification including an indication of the anomaly and the one or more differences, wherein the notification includes a graphical representation of the state identifiers that are present in the message log and the one or more differences between the at least one reference sequence and the state identifiers.

3. The system of claim 2, wherein the anomaly detection module is further configured to:
identify one or more error parameters associated with the one or more differences between the at least one reference sequence and the state identifiers, wherein the notification includes the one or more error parameters, wherein the error parameters identify the one or more services that are associated with the one or more differences.

4. A computer-implemented method comprising:
receiving a message log associated with one or more services provided by one or more computing systems, each message within the message log being generated in response to an event by the one or more services, wherein each message includes a log signature associated with the event;
analyzing the message log for log signatures corresponding to state identifiers associated with the one or more services;
mapping the log signatures to the state identifiers;
comparing the state identifiers to at least one reference sequence of state identifiers associated with the one or more services;
identifying one or more differences between the at least one reference sequence of state identifiers associated with the one or more services and the state identifiers; and
generating a notification based on the one or more differences between the at least one reference sequence and the state identifiers.

5. The method of claim 4, wherein each event is associated with a state of a service of the one or more services and wherein the service includes one or more ordered sequences of states.

6. The method of claim 4, further comprising:
causing a graphical representation of the state identifiers that are present in the message log and the one or more differences between the at least one reference sequence and the state identifiers to be displayed to an administrator.

7. The method of claim 6, wherein the graphical representation includes state identifiers that are present in the message log for one or more services related to a service associated with the one or more differences.

8. The method of claim 4, further comprising:
updating the at least one reference sequence of state identifiers to include a new reference sequence of state identifiers including the differences between the at least one reference sequence and the state identifiers.

9. The method of claim 4, further comprising:
identifying one or more error parameters associated with the one or more differences between the at least one reference sequence and the state identifiers; and
causing the one or more error parameters to be displayed to the administrator.

10. The method of claim 4, wherein the one or more services are initiated in response to an application program interface (API) request received from a client device.

11. The method of claim 4, wherein the log message includes a HTTP message implemented as part of a Representational State Transfer (REST) architecture.

12. A computing system, comprising:
at least one processor; and
a memory device including instructions that, when executed by the at least one processor, cause the computing system to:
receive a message log associated with one or more services provided by one or more computing systems, each message within the message log being generated in response to an event by the one or more services, wherein each message includes a log signature associated with the event;
analyze the message log for log signatures corresponding to state identifiers associated with the one or more services;
map the log signatures to the state identifiers;
compare the state identifiers to at least one reference sequence of state identifiers associated with the one or more services;
identify one or more differences between the at least one reference sequence of state identifiers associated with the one or more services and the state identifiers; and
generate a notification based on the one or more differences between the at least one reference sequence and the state identifiers.

13. The computing system of claim 12, wherein each event is associated with a state of a service of the one or more services and wherein the service includes one or more ordered sequences of states.

14. The computing system of claim 12, wherein the instructions, when executed by the processor, further cause the computing system to:
cause a graphical representation of the state identifiers that are present in the message log and the one or more differences between the at least one reference sequence and the state identifiers to be displayed to an administrator.

15. The computing system of claim 14, wherein the graphical representation includes state identifiers that are present in the message log for one or more services related to a service associated with the one or more differences.

16. The computing system of claim 12, wherein the instructions, when executed by the processor, further cause the computing system to:
update the at least one reference sequence of state identifiers to include a new reference sequence of state identifiers including the differences between the at least one reference sequence and the state identifiers.

17. The computing system of claim 12, wherein the instructions, when executed by the processor, further cause the computing system to:
identify one or more error parameters associated with the one or more differences between the at least one reference sequence and the state identifiers; and
cause the one or more error parameters to be displayed to the administrator.

18. The computing system of claim 12, the one or more services are initiated in response to an application program interface (API) request received from a client device and wherein the log message includes a HTTP message implemented as part of a Representational State Transfer (REST) architecture.

19. A computer-implemented method, comprising:
identifying a log signature for each event within a set of events associated with a service, each event being associated with a state of the service, the service including one or more ordered sequences of states;
assigning a state identifier for each log signature for each event within the set of events;
defining a reference sequence of state identifiers for each of the one or more ordered sequences of states for the service;
storing the reference sequence of state identifiers for each of the one or more ordered sequences of states in a reference state library, wherein an administrator computer is configured to compare a log of events to the reference state library to detect whether an anomaly has occurred during operation of the service.

20. The method of claim 19, wherein a log message including the log signature is generated and sent to the log of events in response to an event occurring at one or more computing systems.

21. The method of claim 19, further comprising:
identifying error parameters associated with each event, the error parameters identifying possible sources of problems associated with each event; and
storing the error parameters in the reference state library.

22. The method of claim 19, wherein assigning each of the state identifiers to one or more ordered sets of state identifiers for each service further comprises:
assigning a start tag to the state identifier associated with a first event of the service; and
assigning an end tag to the state identifier associated with one or more last events of the service.

23. The method of claim 19, wherein the service is initiated in response to an application program interface (API) request received from a client device and wherein the log message includes a HTTP message implemented as part of a Representational State Transfer (REST) architecture.
